(19) United States
(12) Patent Application Publication
(10) Pub. No.: US 2018/0125297 A1
(43) Pub. Date: May 10, 2018

(54) Bun Toasting Assembly

(71) Applicants: David L. Walker, Minooka, IL (US); Debra J. Walker, Minooka, IL (US)

(72) Inventors: David L. Walker, Minooka, IL (US); Debra J. Walker, Minooka, IL (US)

(21) Appl. No.: 15/348,291

(22) Filed: Nov. 10, 2016

(51) Int. Cl. A47J 37/08; H05B 3/68

(52) U.S. Cl. CPC A47J 37/0864; H05B 3/68

(57) ABSTRACT

A bun toasting assembly for permanently toasting a depression into a bun includes a toaster that may have a plurality of buns positioned therein. The toaster is structured to form a depression in the buns. A heating coil is positioned within the toaster to toast the buns thereby facilitating the depression to be permanently toasted into the buns.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIE THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to toasting devices and more particularly pertains to a new toasting device for toasting a depression into a bun.

### BRIEF SUMMARY OF THE INVENTION

An embodiment of the disclosure meets the needs presented above by generally comprising a toaster that may have a plurality of buns positioned therein. The toaster is structured to form a depression in the buns. A heating coil is positioned within the toaster to toast the buns thereby facilitating the depression to be permanently toasted into the buns.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front perspective view of a bun toasting assembly according to an embodiment of the disclosure.

FIG. 2 is a left side phantom view of an embodiment of the disclosure.

FIG. 3 is a right side view of an embodiment of the disclosure.

FIG. 4 is a front phantom view of an embodiment of the disclosure.

FIG. 5 is a cross sectional view taken along line 5-5 of FIG. 2 of an embodiment of the disclosure.

FIG. 6 is a perspective view of a bun with depressions toasted therein of an embodiment of the disclosure.

### DETAILED DESCRIPTION OF THE INVENTION

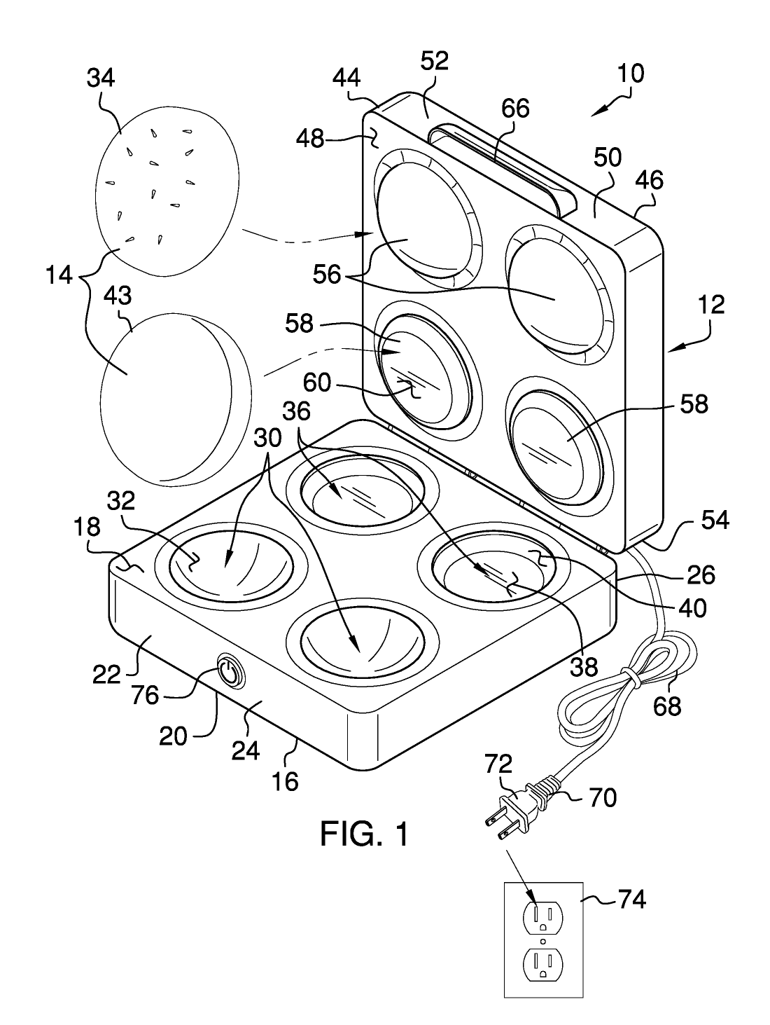

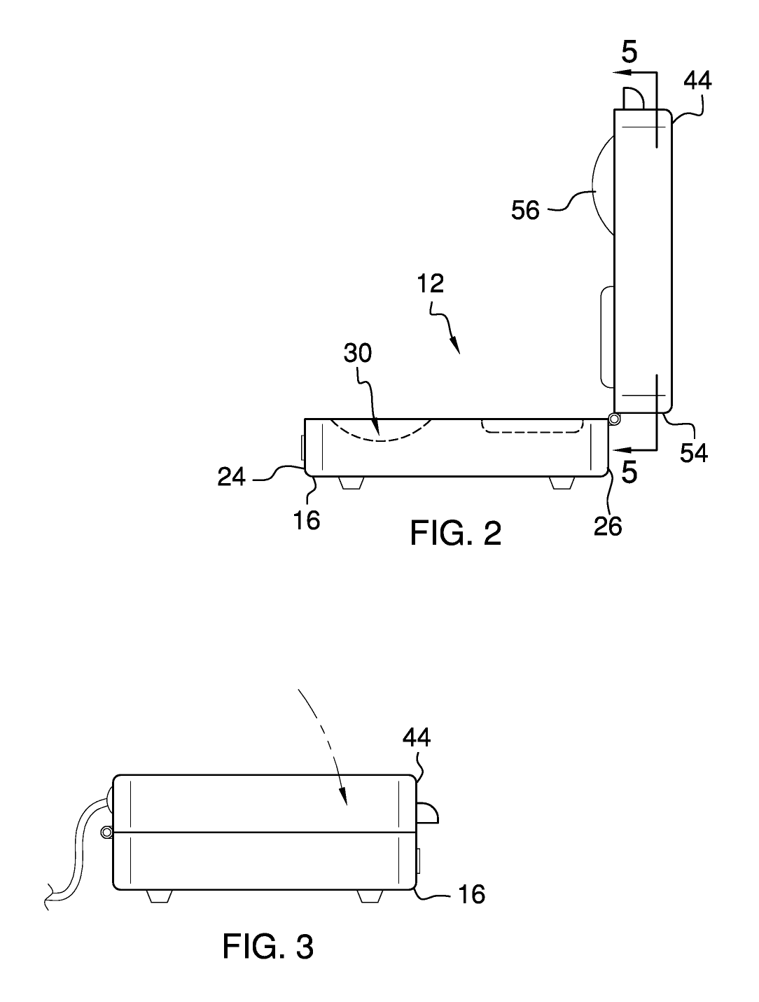

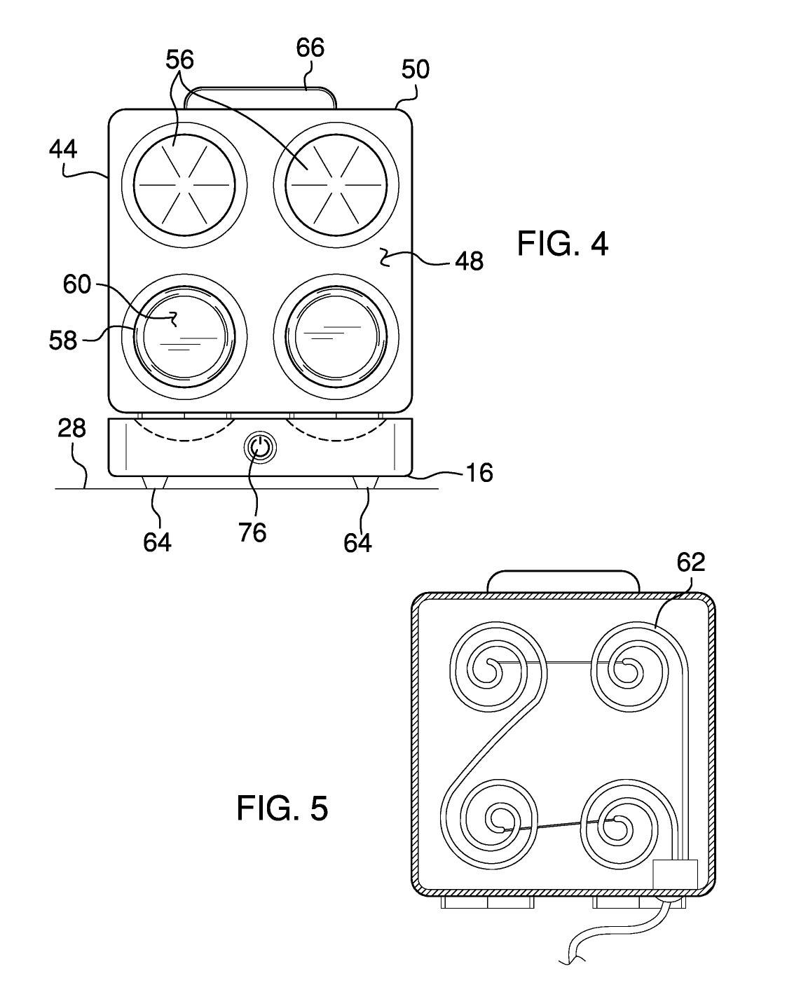

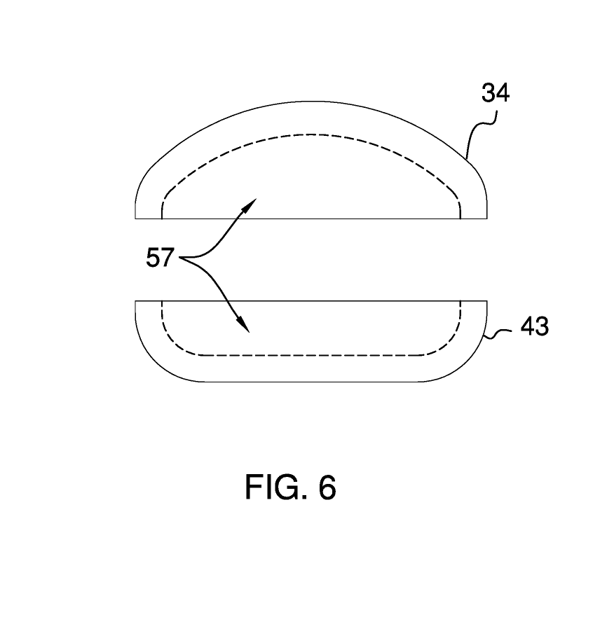

With reference now to the drawings, and in particular to FIGS. 1 through 6 thereof, a new toasting device embodying the principles and concepts of an embodiment of the disclosure and generally designated by the reference numeral 10 will be described.

As best illustrated in FIGS. 1 through 6, the bun toasting assembly 10 generally comprises a toaster 12 that may have a plurality of buns 14 positioned therein. The buns 14 may be hamburger buns or the like. The toaster 12 comprises a first panel 16 that has a top surface 18, a bottom surface 20 and a peripheral edge 22 extending therebetween. The peripheral edge 22 has a front side 24 and a back side 26 and the bottom surface 20 may be positioned on a support surface 28. The support surface 28 may be a table or the like.

The top surface 18 has a pair of first wells 30 extending toward the bottom surface 20 and each of the first wells 30 has a bounding surface 32. The bounding surface 32 is concavely arcuate such that each of the first wells 30 has a hemispherical shape. Each of the first wells 30 is positioned closer to the front side 24 than the back side 26 and a top half 34 of the buns 14 is selectively positioned in a selected one of the first wells 30.

The top surface 18 has a pair of second wells 36 extending toward the bottom surface 20. Each of the second wells 36 has a lower bounding surface 38 intersecting with a peripheral bounding surface 40. The peripheral bounding surface 40 is concavely arcuate between the top surface 18 of the first panel 16 and the lower bounding surface 38. The lower bounding surface 38 is flattened and a bottom half 43 of the buns 14 may be positioned in a selected one of the second wells 36.

A second panel 44 is provided that has an upper surface 46, a lower surface 48 and an exterior edge 50 extending therebetween. The exterior edge 50 has a forward side 52 and a rearward side 54 and the rearward side 54 is hingedly coupled to the back side 26 of the first panel 16. The second panel 44 is selectively positioned in a closed position having the lower surface 48 abutting the top surface 18 of the first panel 16. Moreover, each of the first panel 16 and the second panel 44 are comprised of a thermally conductive material.

The lower surface 48 has a pair of first lobes 56 extending outwardly therefrom. Each of the first lobes 56 is convexly arcuate with respect to the lower surface 48 such that each of the first lobes 56 has a hemispherical shape. Each of the first lobes 56 is aligned with an associated one of the first wells 30 to form a depression 57 in the top half 34 of the buns 14 when the second panel 44 is closed. The lower surface 48 has a pair of second lobes 58 extending outwardly therefrom. Each of the second lobes 58 has a first surface 60 and the first surface 60 is flattened. Each of the second lobes 58 is aligned with an associated one of the second wells 36 to form a depression 57 in the bottom half 43 of the buns 14 when the second panel 44 is closed.

A heating coil 62 is provided and the heating coil 62 is positioned within the second panel 44 such that the heating coil 62 is in thermal communication with the second panel 44. The heating coil 62 is aligned with each of the first lobes 56 and each of the second lobes 58. The heating coil 62 heats the second panel 44 when the heating coil 62 is turned on to toast each of the top half 34 and the bottom half 43 of the buns 14. In this way the depression 57 formed in each of the top half 34 and the bottom half 43 of the buns 14 is permanently toasted into the bun. The heating coil 62 may be an electric heating coil 62 that has an operational temperature ranging between 150 degrees Fahrenheit and 200 degrees Fahrenheit.

A plurality of feet 64 is provided and each of the feet 64 is coupled to the bottom surface 20 of the first panel 16 and each of the feet 64 abuts the support surface 28. A handle 66 is coupled to the first panel 16 and the handle 66 may be gripped thereby facilitating the first panel 16 to be opened and closed. The handle 66 may be positioned on front side 24 of the first panel.

A power cord 68 is coupled to and extends outwardly from the second panel 44. The power cord 68 is electrically coupled to the heating coil 62 and the power cord 68 has a distal end 70 with respect to the second panel 44. A plug 72 is electrically coupled to the distal end 70 of the power cord 68 and the plug 72 may be electrically coupled to a power source 74. The power source 74 may be a female electrical outlet or the like.

A button 76 is coupled to the second panel 44 and the button 76 may be manipulated. The button 76 is electrically coupled to the heating coil 62 such that the button 76 turns the heating coil 62 on and off. The button 76 may be positioned on the forward side 52 of the second panel 44.

In use, the top half 34 of the buns 14 are each positioned in the first wells 30 and the bottom half 43 of the buns 14 are each positioned in the second wells 36. The first panel 16 is closed and the first lobes 56 form a depression 57 in the top half 34 of the buns 14. Each of the second lobes 58 forms a depression 57 in the bottom half 43 of the buns 14 when the first panel 16 is closed. The button 76 is manipulated to turn the heating coil 62 on. In this way the heating coil 62 permanently toasts the depression 57 into each of the top 34 and bottom 42 halves of the buns 14. The depression 57 in each of the top 34 and bottom 42 halves of the buns 14 contains condiments, meat, or other ingredients used to make a hamburger, sloppy joe or other bun based sandwich. In this way the depressions 58 inhibit the condiment, meat and other ingredients from sliding out of the buns 14 when the bun based sandwich is eaten.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A bun toasting assembly being configured to toast a depression into a bun, said assembly comprising:
a toaster being configured to have a plurality of buns positioned therein, said toaster being structured to form a depression in the buns; and
a heating coil being positioned within said toaster is configured to toast the buns thereby facilitating the depression to be permanently toasted into the buns.

2. The assembly according to claim 1, wherein said toaster comprises a first panel having a top surface, a bottom surface and a peripheral edge extending therebetween, said peripheral edge having a front side and a back side, said bottom surface being configured to be positioned on a support surface.

3. The assembly according to claim 2, wherein said top surface has a pair of first wells extending toward said bottom surface, each of said first wells having a bounding surface, said bounding surface being concavely arcuate such that each of said first wells has a hemispherical shape, each of said first wells being positioned closer to said front side than said back side, each of said first wells being configured to have a top half of a bun positioned therein.

4. The assembly according to claim 3, wherein said top surface has a pair of second wells extending toward said bottom surface, each of said second wells having a lower bounding surface intersecting with a peripheral bounding surface, said peripheral bounding surface being concavely arcuate between said top surface of said first panel and said lower bounding surface, said lower bounding surface being flattened, each of said second wells being configured to have a bottom half of the bun positioned therein.

5. The assembly according to claim 2, further comprising a second panel having an upper surface, a lower surface and an exterior edge extending therebetween, said exterior edge having a forward side and a rearward side, said rearward side being hingedly coupled to said back side of said first panel, said second panel being positioned in a closed position having said lower surface abutting said top surface of said first panel.

6. The assembly according to claim 5, wherein:
said toaster has a first panel, said first panel having a pair of first wells; and
said lower surface has a pair of first lobes extending outwardly therefrom, each of said first lobes being convexly arcuate with respect to said lower surface such that each of said first lobes has a hemispherical shape, each of said first lobes being aligned with an associated one of said first wells wherein each of said first lobes is configured to form a depression in a top half of a bun when said second panel is closed.

7. The assembly according to claim 5, wherein:
said toaster has a second panel, said second panel having a pair of second wells; and
said lower surface has a pair of second lobes extending outwardly therefrom, each of said second lobes having a first surface, said first surface being flattened, each of said second lobes being aligned with an associated one of said second wells wherein each of second lobes is configured to form a depression in a bottom half of a bun when said second panel is closed.

8. The assembly according to claim 5, wherein
said second panel has a pair of first lobes and a pair of second lobes; and
said heating coil is positioned within said second panel such that said heating coil is in thermal communication with said second panel, said heating coil being aligned with each of said first lobes and each of said second lobes, said heating coil heating said second panel when said heating coil is turned on wherein said heating coil is configured to toast each of a top half and a bottom half of the buns thereby facilitating the depression formed in each of the top half and the bottom half of the buns to be permanently toasted into the bun.

9. The assembly according to claim 2, further comprising a handle being coupled to said first panel wherein said handle is configured to be gripped thereby facilitating said first panel to be opened and closed.

10. The assembly according to claim 8, further comprising a power cord being coupled to and extending outwardly from said second panel, said power cord being electrically coupled to said heating coil, said power cord having a distal end with respect to said second panel, said distal end having a plug being electrically coupled thereto wherein said plug is configured to be electrically coupled to a power source.

11. The assembly according to claim 8, further comprising a button being coupled to said second panel wherein said button is configured to be manipulated, said button being electrically coupled to said heating coil such that said button turns said heating coil on and off.

12. A bun toasting assembly being configured to toast a depression into a bun, said assembly comprising:
a toaster being configured to have a plurality of buns positioned therein, said toaster comprising:
a first panel having a top surface, a bottom surface and a peripheral edge extending therebetween, said peripheral edge having a front side and a back side, said bottom surface being configured to be positioned on a support surface, said top surface having a pair of first wells extending toward said bottom surface, each of said first wells having a bounding surface, said bounding surface being concavely arcuate such that each of said first wells has a hemispherical shape, each of said first wells being positioned closer to said front side than said back side, each of said first wells being configured to have a top half of a bun positioned therein, said top surface having a pair of second wells extending toward said bottom surface, each of said second wells having a lower bounding surface intersecting with a peripheral bounding surface, said peripheral bounding surface being concavely arcuate between said top surface of said first panel and said lower bounding surface, said lower bounding surface being flattened, each of said second wells being configured to have a bottom half of the bun positioned therein; and
a second panel having an upper surface, a lower surface and an exterior edge extending therebetween, said exterior edge having a forward side and a rearward side, said rearward side being hingedly coupled to said back side of said first panel, said second panel being positioned in a closed position having said lower surface abutting said top surface of said first panel, said lower surface having a pair of first lobes extending outwardly therefrom, each of said first lobes being convexly arcuate with respect to said lower surface such that each of said first lobes has a hemispherical shape, each of said first lobes being aligned with an associated one of said first wells wherein each of said first lobes is configured to form a depression in the top half of the bun when said second panel is closed, said lower surface having a pair of second lobes extending outwardly therefrom, each of said second lobes having a first surface, said first surface being flattened, each of said second lobes being aligned with an associated one of said second wells wherein each of second lobes is configured to form a depression in the bottom half of the bun when said second panel is closed;
a heating coil being positioned within said second panel such that said heating coil is in thermal communication with said second panel, said heating coil being aligned with each of said first lobes and each of said second lobes, said heating coil heating said second panel when said heating coil is turned on wherein said heating coil is configured to toast each of the top half and the bottom half of the buns thereby facilitating the depression formed in each of the top half and the bottom half of the buns to be permanently toasted into the bun;
a plurality of feet, each of said feet being coupled to said bottom surface of said first panel wherein each of said feet is configured to abut a support surface;
a handle being coupled to said first panel wherein said handle is configured to be gripped thereby facilitating said first panel to be opened and closed;
a power cord being coupled to and extending outwardly from said second panel, said power cord being electrically coupled to said heating coil, said power cord having a distal end with respect to said second panel, said distal end having a plug being electrically coupled thereto wherein said plug is configured to be electrically coupled to a power source; and
a button being coupled to said second panel wherein said button is configured to be manipulated, said button being electrically coupled to said heating coil such that said button turns said heating coil on and off.
